(19) United States
(12) Patent Application Publication
(10) Pub. No.: US 2006/0210877 A1
(43) Pub. Date: Sep. 21, 2006

(54) Flexible pasted anode, primary cell with pasted anode, and method for making same

(75) Inventors: David J. Manko, Seabrook, TX (US); Lawrence A. Tinker, College Station, TX (US); Ramesh C. Kainthla, College Station, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Rechargable Battery Corporation

(21) Appl. No.: 11/259,340

(22) Filed: Oct. 25, 2005

Related U.S. Application Data
(60) Provisional application No. 60/662,085, filed on Mar. 15, 2005.

(51) Int. Cl. H01M 4/62; H01M 4/42; H01M 4/48; H01M 4/66; H01M 4/70; H01M 4/74; H01M 6/00

(52) U.S. Cl. 429/217; 429/127; 429/229; 429/231; 429/245; 429/241; 429/242; 252/182.1; 29/623.1

(57) ABSTRACT

The invention includes a flexible pasted anode comprising a flexible current collector and a paste comprising zinc particles and at least one block copolymer binder, wherein said flexible current collector and said paste form a unit. The invention includes primary cell comprising the flexible pasted anode, a cathode, and electrolyte. The invention also includes an anode paste comprising zinc particles and at least one block copolymer, wherein said paste is suitable for use in an anode. The invention further includes a method of manufacturing zinc anode comprising combining zinc powder, block copolymer, and solvent to form a paste, depositing the paste onto a current collector, and drying the wet pasted anode, and a method of manufacturing a primary cell comprising: forming a flexible pasted zinc anode to form a convoluted pasted zinc anode, inserting said convoluted pasted zinc anode into a cell container, and filling said container with electrolyte.

### CROSS REFERENCE TO RELATED APPLICATIONS

This application claims priority to U.S. provisional application Ser. No. 60/662,085, filed Oct. 25, 2004, which is incorporated herein by reference.

### BACKGROUND OF THE INVENTION

This invention generally relates to electrochemical battery cells, with a negative electrode using metal in particulate form. More particularly the invention pertains to zinc electrodes in primary alkaline, secondary nickel/zinc, and secondary silver/zinc cells.

Small electrochemical cells are used by consumers to power a variety of devices including cameras, flashlights, toys, radios, timepieces, calculators, and other electronic devices. There is demand in the marketplace for both low-cost consumable electrochemical cells, such as primary alkaline cells which may be used, for example, in one-time use cameras, and secondary cells which may be recharged and reused.

Alkaline cells used in the consumer marketplace typically comprise a cylindrical cathode and a gelled anode inside the cylindrical cathode that includes zinc particles and an aqueous electrolyte absorbed by the gel dispensed on a current collector. Such a configuration is often referred to as a bobbin configuration or a bobbin cell. Alkaline cells comprising gelled anodes can be manufactured at a low cost relative to other battery types, are widely available and provide a low-cost and convenient energy source for many applications. While having these and other advantages, alkaline cells comprising gelled anodes have disadvantages. For example, zinc from gelled anodes can easily migrate within the battery cell, and migration of zinc species to the cathode can decrease the active life of the cell. The energy output of the cell is also limited by the anode to cathode interfacial surface area, which in the bobbin configuration is less than the external surface area of the cylinder and determined by the zinc content and microporosity of the gel. In addition, gelled anodes are typically formed within the cell during manufacture of the cell, rather than pre-manufactured and stored for future insertion in a cell. In the latter case such anodes would likely have a relatively short shelf life.

Pasted anodes can be mass-produced at a relatively low cost and stored for later inclusion in a manufactured cell. U.S. Pat. Nos. 6,207,326 (Kawakami, et al.); 5,888,666 (Kawakami); 5,837,402 (Araki, et al.); 5,728,482 (Kawakami, et al.); and U.S. application Ser. No. 2002/0164530 disclose a pasted zinc anode comprising zinc, zinc powder, and a binder rolled onto a current collector used in a secondary cell. However, pasted zinc anodes as currently used in the art also have disadvantages. Pasted anodes are typically manufactured in the discharged state with zinc in the form of Zn²⁺ (such as in zinc oxide (ZnO)) rather than in the charged state (as Zn⁰). Cells with pasted anodes manufactured in the discharged state must be charged after cell assembly and before use; thus pasted anodes are limited to secondary cells. Pasted anodes as currently known in the art are also rigid, which limits the configuration of the anode within the cell.

### BRIEF SUMMARY OF THE INVENTION

The invention seeks to provide a zinc anode that may be mass-produced prior to cell construction, that is appropriate for use in a primary cell, and that can be formed into various geometries in a cell. In accordance with the invention, this object is accomplished in a flexible pasted zinc anode comprising (a) a flexible current collector, and (b) a paste comprising (i) zinc particles and (ii) at least one block copolymer binder, wherein said flexible current collector and said paste form a unit. The invention also seeks to provide a primary cell with a higher discharge capacity than traditional gelled anodes. In accordance with the invention, this object is accomplished in a primary cell comprising (1) a flexible pasted zinc anode comprising (a) a flexible current collector, and (b) a paste comprising (i) zinc particles and (ii) at least one block copolymer binder, wherein said flexible current collector and said paste form a unit, (2) a cathode, and (3) a liquid electrolyte. The invention also seeks to provide a method of manufacturing cells and anodes as described above.

### BRIEF DESCRIPTION OF THE DRAWINGS

FIG. 1 is a diagrammatic view of a system for making an anode embodying the invention.

FIG. 2 is a diagrammatic view of a preferred system for making an anode embodying the invention.

FIG. 3 is a diagram of one configuration of a primary cell comprising a flexible pasted anode and a cathode embodying the invention.

FIG. 4A-4D are diagrams of another configuration of a primary cell comprising a flexible pasted anode and a cathode embodying the invention.

FIG. 5 is a graph of the cell capacity versus cell voltage of three AA alkaline cells made according to the embodiment of the invention provided in Example 3.

### DETAILED DESCRIPTION OF THE INVENTION

The present invention now will be described more fully hereinafter with reference to the accompanying drawing, in which one, but not all embodiments of the invention are shown. Indeed, these inventions may be embodied in many different forms and should not be construed as limited to the embodiments set forth herein; rather, these embodiments are provided so that this disclosure will satisfy applicable legal requirements.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. Paste

Anode pastes according to the invention comprise zinc particles and at least one block copolymer, optionally a gelling agent, and optionally zinc oxide. Zinc particles according to the invention include zinc granules, fibers, powders, pellets, flakes, and other suitably small solid forms of zinc. As with many other types of small solids, the size of zinc particles according to the invention may vary and may include a distribution of multiple sizes within a range. The sizes of the zinc particles may include any of the distributions of zinc particles as used in gelled or other pasted zinc electrodes. Preferred average particle diameter of the zinc particle distribution is 100-160 μm, particularly 130-150 μm. The zinc particles may also include additives including, but not limited to, bismuth, indium, aluminum, lead, and iron. An example of an acceptable zinc particle distribution with additives according to the invention is BIA 100 300 100 d140 zinc powder as marketed by Umicore.

Block copolymer binders according to the invention may include any block copolymer that is compatible with zinc, the electrolyte solution, and other components of the cell and that also will maintain flexibility without cracking when bent. As such, the block copolymers preferably have elastomeric qualities. Preferred elastomeric block copolymers include styrenic copolymers. Particularly preferred are styrene-ethylene/butylene-styrene (SEBS) copolymers, such as those manufactured by Kraton Polymers as Kraton™ G series polymers, including Kraton G 1651 and G 1901.

Other additives or auxiliaries may optionally be added to the solid phase of the anode paste according to the invention. A gelling agent may be added to increase the absorbency of the electrolyte by the anode. Examples of common gelling agents include crosslinked acrylic acid carbomers (such as Carbopol™ 940), polyethylene oxide, polyacrylic acid, and various forms of cellulose. Gelling agents according to the invention must be compatible with zinc, the electrolyte solution, the block copolymer, and other components of the anode and electrolyte solution during cell use. Preferred gelling agents are crosslinked acrylic acid carbomers (such as Carbopol™ 940).

The anode paste according to the invention may also include zinc oxide. Zinc oxide is a reaction product of zinc with hydroxide solutions, and is included in an anode paste and electrolyte solution to maintain an equilibrium of zinc oxide and potassium hydroxide in the cell to prevent zinc depletion through the formation of zinc oxide. For anodes used in primary cells according to the invention, the preferred quantity of zinc oxide is less than 5% of the dry weight of the anode paste, particularly preferably 0.5 to 2.5% of the dry weight, most preferably about 0.5% by weight. The preferred ratio of zinc metal (Zn⁰) to zinc oxide (ZnO) is preferably from 35:1 to 220:1 by weight, most preferably about 190:1 to 220:1 by weight.

In addition to the above-mentioned components, the anode paste at the time of application to the current collector may comprise at least one solvent. The solvent may be used to obtain a paste-like consistency with the dry ingredients and may be used to lower the viscosity to ease application of the paste. The solvent is selected to be compatible with the other paste components and to promote defect-free and uniform drying of the anode. Organic solvents, particularly petroleum distillates such as Stoddard solvent or other aliphatic or aromatic hydrocarbons may be used, and such solvents are readily available. Mixtures of different organic solvents may also be used. Preferred solvents include Stoddard solvent and VM&P naphtha. After application to the current collector, the majority of the solvent is removed from the paste via an evaporation process. However, some residual solvent may remain in the paste following the evaporation process.

A typical paste at the time of application to a current collector comprises 75-80% zinc (Zn⁰) particles, 0-0.5% zinc oxide, 10-20% solvent, 0.2-2.5% block copolymer binders, and up to 5% gelling agents. The viscosity range of the paste at the time of application is preferably 25,000-45,000 cps.

2. Anode

Pasted zinc anodes according to the current invention comprise anode paste described herein and a flexible current collector. Materials for current collectors for anodes according to the present invention may include any material that is electrochemically conductive, that is flexible, and that is not electrochemically reactive with zinc and reduces hydrogen gassing in an alkaline. Suitable materials may include tin plated steel, copper, or brass. The current collector may be in a form suitable for applying a paste, including but not limited to screen or mesh, perforated metal, and expanded metal (such as that available under the trade name Exmet®). The paste may be applied to or “pasted” with the current collector to form a pasted zinc anode. Following the pasting process, the pasted zinc anode should form a unit that can be deformed without separation of the paste from the current collector.

Pasted zinc anodes according to the invention may be produced in batch, continuous, or semi-continuous processes. One preferred process comprises combining dry paste ingredients including zinc particles, optionally zinc oxide particles, optionally one or more gelling agents, and optionally one or more auxiliaries to form a dry particulate mixture. An elastomeric block copolymer and a solvent are combined to form a solution. The solution may be heated to reach a desired viscosity, then the dry particulate mixture is added to the solution to form a zinc anode paste. Heating after addition of dry particles is alternatively attempted.

A particularly preferred process comprises combining zinc powder and up to 2.5% zinc oxide (based on the combined weight of the zinc powder and zinc oxide) to thoroughly distribute the zinc oxide in the zinc powder to form a dry zinc mixture. In a separate container, SEBS block copolymer (about 2.5% by weight, based on the total weight of the polymer solution) and Stoddard solvent are combined and heated to 40-50° C. to dissolve the polymer and form a polymer solution. The dry zinc mixture and polymer solution is combined at a ratio of about 5 parts dry zinc mixture to 1 part polymer solution to form a viscous slurry/paste, and additional Stoddard solvent (about 0.25 parts) is added to reduce the viscosity and form a paste for application to the current collector.

After manufacture, the pasted strips may be cut into anodes and immediately fabricated into batteries. Alternately, the pasted strips may be cut into anode portions and stored for inclusion in cells to be manufactured at a later date. Prior to storage, the pasted anodes may be wrapped in a separator material, such as flexible nonwoven separator material made from a polyolefin, such as nonwovens (such as FS 2203) manufactured under the trade name Viledon® by Freudenberg Nonwovens, or other suitable separator materials, such as separators manufactured by Advanced Membrane Systems, Inc under the trade name FAS™, or the like.

3. Process for anode manufacture

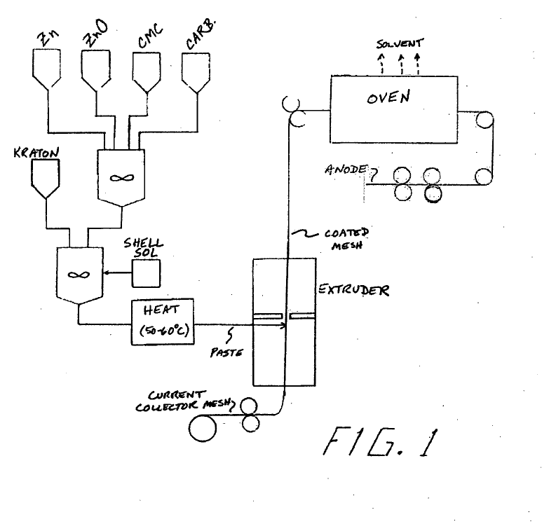

One process for manufacturing flexible zinc anode according to the invention is illustrated in FIG. 1. In this process, zinc powder, zinc oxide, and gelling agent are proportionally weighed and fed to a blender, where they are thoroughly mixed. Block copolymer binder (Kraton G-1654x) is weighed and fed into a tank of solvent naphtha (Shell-Sol 340 HT), where they are mixed until the binder dissolves in the solvent naphtha. The weighed blended solids are then delivered to the binder/solvent in either the initial mixing tank or a second mixing tank. The weighed blended solids are mixed with the binder/solvent to form a paste or slurry. The paste or slurry is heated to an appropriate temperature, such as 50-60° C. to achieve a desired viscosity. The process may proceed by mixing batches of the components or by providing a continuous raw ingredient feed mix.

The resultant paste is deposited to a current collector, preferably by delivering the paste at a constant volumetric flow rate to a coating or extruding device including coating dies, roll coaters, and doctor blades. The current collector is preferably a continuous roll of perforated brass foil. The thickness of the coated sheet anode web may be adjusted using settings on the coating device or by using shims on the device. After deposition of the paste, the thickness of the anode may be further adjusted by calendaring, a doctor blade, or other suitable apparatus. The preferred thickness of the pasted sheet anode is 0.5 mm to 2.5 mm, with the paste evenly distributed on each side of the current collector.

After deposition of the anode paste, solvent is driven from the sheet anode. Methods for removal of solvent include but are not limited to passive air drying, forced air ovens, and infrared ovens. After the solvent removal process, selected or residual amounts of solvent may remain in the sheet anode. After solvent removal, the thickness of the pasted anodes is further adjusted by calendaring or other processes.

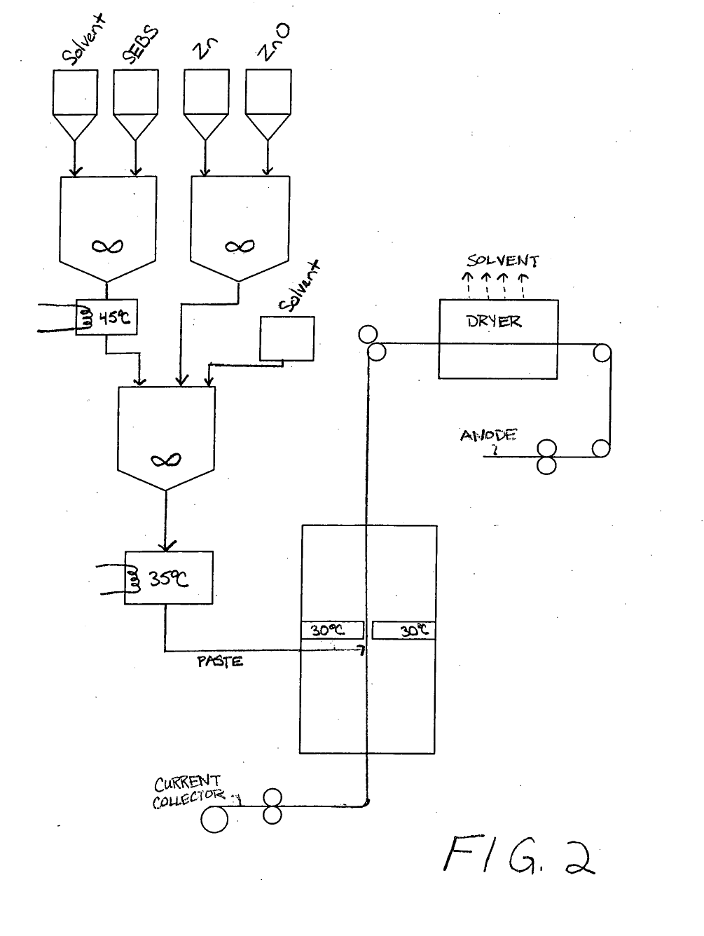

A second process for manufacturing flexible zinc anode according to the invention is illustrated in FIG. 2. In this process, zinc powder and zinc oxide are proportionally weighed and fed to a blender, where they are thoroughly mixed. SEBS block copolymer binder (Kraton G-1654x) is weighed and fed into a tank of Stoddard solvent, where they are mixed and heated to 40-50° C. until the binder dissolves in the solvent. The weighed blended solids are then delivered to the binder/solvent in either the initial mixing tank or a second mixing tank. The weighed blended solids are mixed with the binder/solvent, and additional solvent is optionally added, to form a paste or slurry. The paste or slurry may be optionally heated or cooled to an appropriate temperature. to achieve a desired viscosity and handling temperature. The process may proceed by mixing batches of the components or by providing a continuous raw ingredient feed mix.

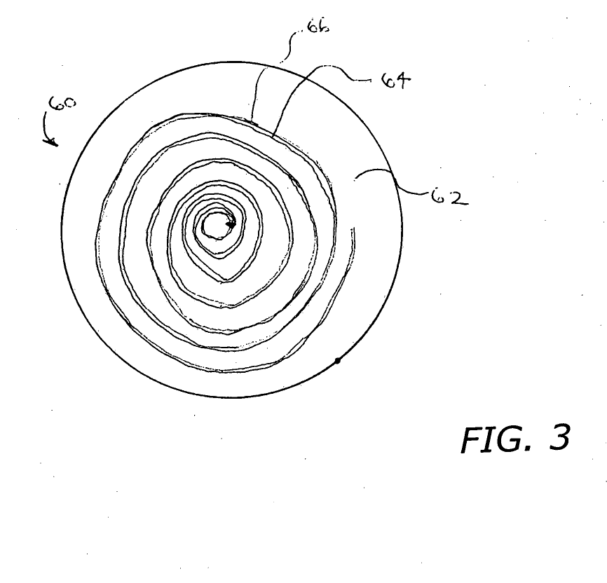

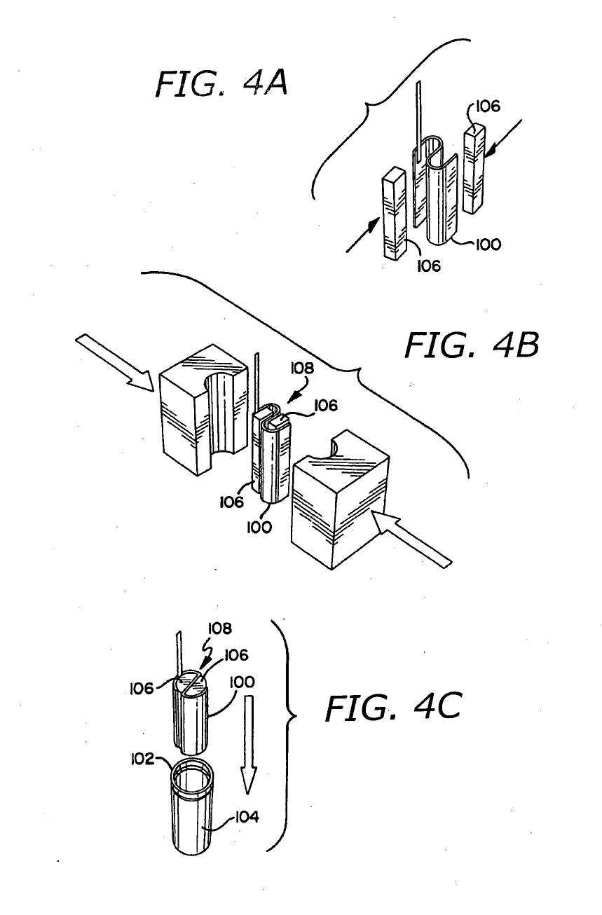

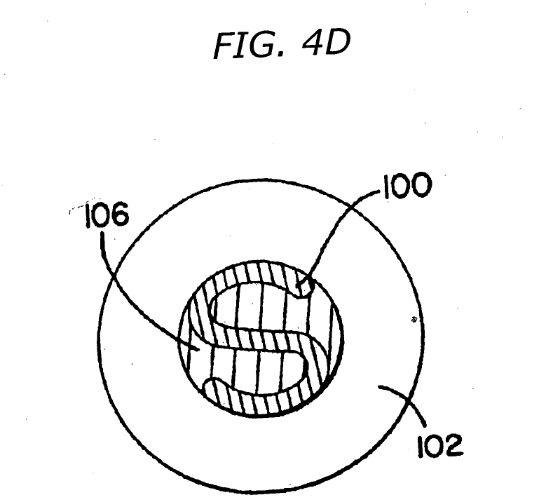

The sheet anode may then be cut to size to fit cells as desired. The sheet anode is flexible and may then be formed or folded into various configurations, such as spiral, prismatic, arcuate, single fold, partial fold and multiple fold configurations. FIG. 3 and FIG. 4 are top views of primary cells comprising a flexible pasted anode (64) formed or folded in a primary cell (60). Other exemplary anode configurations within a primary cell are provided in U.S. Publication No. 2005/015397, which is herein incorporated by reference.

4. Cells

Primary cells according to the present invention comprise pasted zinc anodes as described herein, a cathode, and an electrolyte. Suitable cathodes for a primary alkaline cell include various conventional types. Aqueous potassium hydroxide is the preferred electrolyte, although other known electrolytes may be used. In an alkaline battery using a zinc anode and potassium hydroxide electrolyte according to the present invention, the following reaction occurs at the anode:
Zn₍ₛ₎+2 OH⁻_{(aq)}→Zn(OH)₂₍ₛ₎+2e−
For primary cells according to the present invention comprising a manganese dioxide cathode, the following reaction occurs at the cathode:
2 MnO₂₍ₛ₎+H₂O₍ₗ₎+2e−→Mn₂O₃₍ₛ₎+2 OH⁻_{(aq)}

Cells according to the present invention may include, rigid, flexible, or deposited (filled) cathodes.

As shown in the embodiment depicted in FIG. 3, the anode (64) is a thin structure in a coiled configuration. However, other types of configurations may be utilized that have a large surface area. As shown in FIG. 3, the cell comprises a flexible anode (64) that is encapsulated by a separator (66). The cathode (62) may be formed from, for example, manganese dioxide, a conductive paste, and an additive comprising one or more of a binder, electrolye, and recombination catalyst. The separator (66) comprises a laminated or composite material typically used as a separator material. In a preferred embodiment, the separator (66) comprises a combination of an absorbent fibrous sheet material wettable by an electrolyte and an insulating material that is impermeable to small particles while being permeable to ions. The absorbent material is preferably a macro-porous structure, such as a non-woven polyolefin. Shorting is prevented by the insulating material, which may comprise one or more layers of a micro-porous or non-porous material laminated to or coated onto the absorbent fibrous sheet material. As an example, the insulating material may comprise one or more cellophane membranes laminated onto a non-woven polyolefin sheet. Another example of an insulating material is one or more coatings of regenerated cellulose or viscose coated onto and partially impregnating the non-woven polyolefin sheet, resulting in a composite material. Another suitable coating comprises a polymeric material such as sulfonated polyphenylene oxide and its derivatives. One or more layers of the laminated or composite material are preferably wound or coiled to form a spiral-like or coiled structure as shown.

As shown in the embodiment depicted in FIG. 4A-4C, the electrode assembly comprises an S-shaped flexible pasted anode (100) and elongated masses of cathode material (106) inserted in the more open gaps of the folded inner anode, surrounded by the outer cathode (102). The flexible pasted anode (100) may be grasped with a mandrel and rotated into a desired form, such as the S-shaped form. The flexible pasted anode (100) can be rotated against an external point of contact or down through a funnel shaped orifice. In one embodiment, prior to inserting the folded inner anode (100) within the cell housing (104), elongated masses of inner cathode material (106) can be inserted into the more open gaps (see FIG. 4A) and the folded inner anode (100) and elongated masses of the inner cathode material (106) compressed (see FIG. 4B) into a single electrode subassembly (108) and then placed within the ring of the outer cathode material (102) and within the cell container (104) (see FIG. 4C). In another embodiment, the folded inner anode (100) can be placed inside the ring of the outer cathode material (102) in the cell container (104) and the inner portion of the cathode material (106) is then introduced into the void spaces via injection through the hollow mandrel or through some other nozzle placed in the void space and withdrawn as the cathode material fills in.

### EXAMPLES

### Example 1

The following ingredients were dry blended in a beaker:

| | |
|---|---|
| Zinc Powder | 94.5% |
| Zinc oxide | 3.00% |
| Carboxymethylcellulose (CMC) | 1.00% |
| Carbomer | 0.50% |

A mixture of SEBS block copolymer (5.2 g of Kraton G1654x) and solvent naphtha (102 g of Shell Sol 340 HT) was heated until the mixture liquefied. 45 g of this liquefied solution was added to 297 g of the dry mixture above, and the mixture paste was kept hot on a hotplate. A sheet of polytetrafluoroethylene (PTFE) was placed on a piece of polyvinylchloride (PVC), and a strip of tin-coated substrate measuring 6 inches by 3 inches was placed over the PTFE. Some of the mixture paste was poured onto the tin-coated substrate and covered with another sheet of PTFE to form a “sandwich.” The mixture paste was spread over the substrate on the one side of the sandwich with a rolling pin, and the sandwich was flipped, material was added to the other side of the tin substrate and rolled with a rolling pin. The sandwich was covered with 0.040 inch shims and passed through a roll mill twice, rotating the sandwich each time. The PTFE sheets were removed and excess paste was removed from the edges of the substrate. The pasted substrate was dried on a screen overnight. The pasted substrate was then cut into four electrodes, each with a paste weight of approximately 4.6 to 4.7 grams and a thickness of approximately 0.040 inch.

### Example 2

The following ingredients were dry blended in a beaker to form a dry mixture:

| | | |
|---|---|---|
| Zinc Powder | 82.7% | 55 g |
| Zinc fiber | 15.0% | 10 g |
| Carboxymethylcellulose (CMC) | 1.5% | 1 g |
| Carbomer | 0.8% | 0.54 g |

10 grams of 1% SEBS copolymer in solvent naphtha was added to the dry mixture under heat to form a paste, and the paste was rolled out onto a current collector as described in Example 1. The pasted substrate was dried and cut into 4 electrodes.

### Example 3

A base solvent mixture of 2.51 grams (2.5%) SEBS copolymer and 98.34 grams (97.5%) Stoddard solvent were combined and heated to 45° C. in a water bath until the copolymer dissolved in the solvent. In a separate container, 250 grams of a commercial zinc powder (d₅₀=140 μm) and 1.25 grams of zinc oxide powder were combined to form a zinc mixture. An aliquot of 50.91 grams of the base solvent mixture was removed and added to a clean container, and the zinc mixture was added to the solvent mixture and stirred to combine. An additional 12.45 grams of Stoddard solvent was added to the mixture, forming a paste. The paste was then cooled to approximately 35° C.

A vertical coating die was set up so that a perforated metal strip current collector substrate could be pulled through the die. The die opening was set to approximately 0.075 inches. The die was then heated to maintain a temperature of approximately 30° C. The coating die was then filled with the paste. The substrate was pulled through the die to coat the paste onto each side of the current collector substrate. After the current collector substrate was coated with the paste, it was air dried to evaporate the solvent. After drying, the resulting pasted strip was approximately 0.16 mm thick with a porosity of approximately 16%.

The pasted strip was cut into electrodes that were 31 mm by 41 mm. The electrodes had a non-coated strip approximately 2 mm wide at one end of the electrode. The electrodes were then wrapped with two layers of a flexible separator material with the inner layer made from a nonwoven polyolefin material and the outer layer made from a microporous membrane material.

Several AA zinc-manganese dioxide cells were fabricated using the electrodes in the configuration as described by FIG. 4. Each of the cells was then tested with a Digital Cameral Pulse test using the test method described below.

Test Method for Cells:

1. A 1.5 W pulse is applied to the cell for 2.0 seconds.
2. A 0.65 W pulse is applied for 28 seconds.
3. Steps 1 and 2 are repeated ten times.
4. The cell is allowed to come to open circuit for 55 minutes.
5. Steps 1-4 are repeated until the cell voltage reaches a cutoff of 1.05 V.

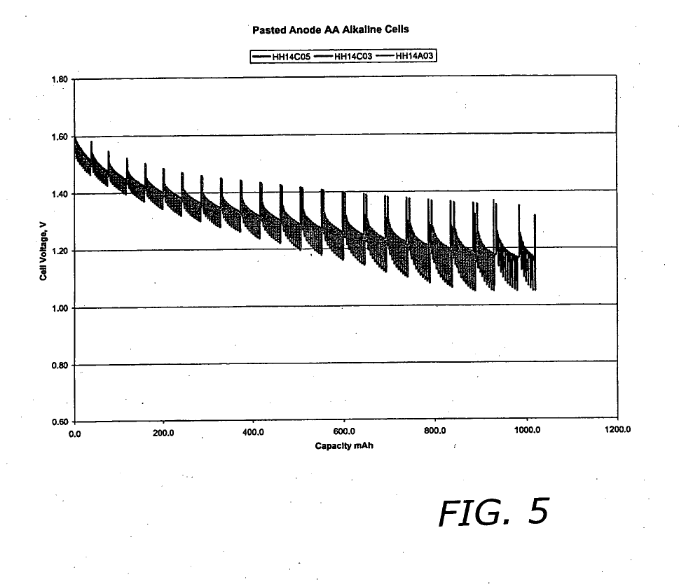

Results from the testing of these cells are shown in FIG. 5, and indicate that the electrodes as manufactured using this process are suitable for use in alkaline cells.

That which is claimed:

1. A flexible pasted anode comprising
(a) a flexible current collector, and
(b) a paste comprising
(i) zinc particles, and
(ii) at least one block copolymer binder,
wherein said flexible current collector and said paste form a unit.

2. The anode as claimed in claim 1, wherein the paste further comprises a gelling agent.

3. The anode as claimed in claim 1, wherein the paste further comprises zinc oxide.

4. The anode as claimed in claim 3, wherein the concentration of zinc oxide is less than 5% by weight, based on the total weight of the paste.

5. The anode as claimed in claim 1, wherein the binder comprises a styrene block copolymer.

6. The anode as claimed in claim 1, wherein said block copolymer binder includes SEBS block copolymer.

7. The anode as claimed in claim 1, wherein said current collector is perforated brass foil.

8. The anode as claimed in claim 1, wherein said current collector comprises a metal mesh.

9. The anode as claimed in claim 1, wherein said current collector comprises expanded metal.

10. The anode as claimed in claim 1, wherein the anode is flexible.

11. The anode as claimed in claim 10, wherein the anode is foldable.

12. The anode as claimed in claim 10, wherein the anode has a configuration selected from the group consisting of spiral, prismatic, and multiple fold configurations.

13. The anode as claimed in claim 1, wherein the zinc particles as manufactured are present solely as Zn⁰.

14. An anode paste comprising
(a) zinc particles, and
(b) at least one block copolymer,
wherein said paste is suitable for use in an anode electrochemical cell.

15. The anode paste as claimed in claim 14, further comprising a gelling agent.

16. The anode paste as claimed in claim 14, further comprising zinc oxide.

17. The anode paste as claimed in claim 16, wherein the concentration of zinc oxide is less than 5% by weight, based on the total weight of the paste.

18. The anode paste as claimed in claim 14, wherein the anode is flexible.

19. The anode paste as claimed in claim 14, wherein said block copolymer binder includes SEBS block copolymer.

20. The anode paste as claimed in claim 14, wherein the zinc particles are present solely as Zn⁰.

21. A primary cell comprising
(a) a zinc anode comprising
(i) a flexible current collector, and
(ii) a paste a comprising
(A) zinc particles, and
(B) at least one block copolymer binder,
wherein said flexible current collector and said paste form a unit,
(b) a cathode, and
(c) electrolyte.

22. The cell as claimed in claim 21, wherein the zinc anode is charged.

23. The cell as claimed in claim 21, wherein the paste further comprises zinc oxide, being less than 5% based on the total weight of the paste.

24. The cell as claimed in claim 21, wherein said block copolymer binder includes SEBS block copolymer.

25. The cell as claimed in claim 21, wherein said flexible current collector comprises perforated brass foil.

26. The cell as claimed in claim 21, wherein said current collector comprises a metal mesh.

27. The cell as claimed in claim 21, wherein said current collector comprises expanded metal.

28. The cell as claimed in claim 21, wherein the cell has a configuration selected from the group consisting of spiral, prismatic, and multiple fold configurations.

29. A method of manufacturing zinc anode comprising
(a) combining zinc powder, block copolymer, and solvent to form an anode paste,
(b) depositing said anode paste onto a current collector to form a wet pasted anode, and
(c) drying said wet pasted anode to form a dry pasted anode.

30. The method as claimed in claim 29, wherein said combining step includes:
(i) combining zinc powder and binder to form a dry mixture,
(ii) combining a block copolymer with a solvent to form a binder solution, and
(iii) combining said dry mixture with said binder solution to form an anode paste.

31. The method as claimed in claim 29, further comprising heating the anode paste formed in (a) prior to depositing in (b).

32. The method as claimed in claim 29, wherein the anode paste is deposited onto said current collector in step (b) with an extruder.

33. The method as claimed in claim 29, further comprising rolling or calendaring said wet pasted anode to achieve the desired thickness after (b).

34. A method of manufacturing a primary cell comprising:
(a) forming a flexible pasted zinc anode to form a convoluted pasted zinc anode,
(b) inserting said convoluted pasted zinc anode into a cell container, and
(c) filling said container with electrolyte.
